(19) United States
(12) Patent Application Publication
(10) Pub. No.: US 2007/0032583 A1
(43) Pub. Date: Feb. 8, 2007

(54) Moisture-curable polyurethane composition with improved storage stability and method for preparing the same

(76) Inventors: Jae Chul Han, Nam-ku (KR); Hyun Jun Jin, Joong-ku (KR); Cheol Sik Yang, Joong-ku (KR)

Correspondence Address: ABELMAN, FRAYNE & SCHWAB, 666 THIRD AVENUE, 10TH FLOOR, NEW YORK, NY, 10017, US

(21) Appl. No.: 11/499,301

(22) Filed: Aug. 3, 2006

(30) Foreign Application Priority Data
Aug. 4, 2005 (KR) 10-2005-0071442

(51) Int. Cl. H01B 3/44

(52) U.S. Cl. 524/264; 524/590

(57) ABSTRACT

Disclosed herein is a one-component type moisture-curable polyurethane composition with improved storage stability. The polyurethane composition comprises a prepolymer prepared by reacting a polyol having a weight-average molecular weight of 1,000 to 5,000 with a mixture of an aromatic diisocyanate and an aliphatic diisocyanate in a weight ratio of 1:1 to 1:0.1, an inorganic paste, and a blocked amine compound and a monomeric vinyl silane as additives for removing moisture from the inorganic paste. The polyurethane composition has improved storage stability even in general open equipment. Further disclosed is a method for preparing the polyurethane composition.

### TECHNICAL FIELD

The present invention relates to a moisture-curable polyurethane composition and a method for preparing the polyurethane composition. More specifically, the present invention relates to a one-component type moisture-curable polyurethane composition that can be stably stored in general open equipment without using any expensive closed equipment, and a method for preparing the polyurethane composition.

### BACKGROUND ART

The storage stability of conventional prepolymers is dependent on various factors, such as the moisture content of polyols, the amount of residual catalysts and the content of residual monols. Particularly, the moisture content of polyols should be limited to below 100 ppm in order to obtain satisfactory storage stability. Urethane producers generally dehydrate polyol products with a moisture content of 300 to 500 ppm at 110° C. for 12 hours or more before use. Further, urethane producers currently use trifunctional polyols with a molecular weight larger than 5,000 in terms of the performance of final products. Such polyols contain 0.01 to 0.05 meq/g of monols having an unsaturated hydrocarbon at one side. This high level of monols reduces the average number of functional groups within polyols, which makes it difficult to control the molecular weight of final products and becomes a major factor causing a deterioration in the performance of final products.

Theoretical correlations in monol content and average number of functional groups (Favg) between two polyol products, i.e. DF-2000 (Favg: 2, Mw: 2,000) and TF-5000 (Favg: 3, Mw: 5,000), both of which are available from SKC Co., Ltd., are shown in Table 1.

TABLE 1

| | |
|---|---|
| DF-2000 | TF-5000 |

| | Average | | Average |
|---|---|---|---|
| Monol | numbers of | Monol | numbers of |
| content | functional groups | content | functional groups |
| (meq/g) | (F_{avg}) | (meq/g) | (F_{avg}) |
| 0.001 | 1.998 | 0.001 | 2.990 |
| 0.005 | 1.990 | 0.005 | 2.951 |
| 0.009 | 1.982 | 0.009 | 2.913 |
| 0.013 | 1.974 | 0.013 | 2.875 |
| 0.017 | 1.967 | 0.017 | 2.839 |
| 0.021 | 1.959 | 0.021 | 2.804 |
| 0.025 | 1.951 | 0.025 | 2.769 |
| 0.029 | 1.944 | 0.029 | 2.736 |
| 0.033 | 1.936 | 0.033 | 2.703 |
| 0.037 | 1.929 | 0.037 | 2.671 |
| 0.041 | 1.921 | 0.041 | 2.639 |
| 0.045 | 1.914 | 0.045 | 2.609 |
| 0.049 | 1.907 | 0.049 | 2.579 |
| 0.053 | 1.899 | 0.053 | 2.550 |
| 0.057 | 1.892 | 0.057 | 2.521 |

As can be seen from the data shown in Table 1, the higher the monol content, the lower the average numbers of functional groups. Thus, prepolymers prepared from conventional polyoxypropylene polyols having a monol content of 0.01-0.05 meq/g have limited performance. For example, it is difficult to control the molecular weight of polyurethane products using the prepolymers.

U.S. Pat. No. 6,036,879 discloses the production of a polyurethane sealant using a polyoxypropylene polyol with a monol content of 0.02 meq/g or lower and a polyoxybutylene polyol, and the physical properties of the polyurethane sealant. According to the above patent, the polyurethane shows considerably improved physical properties, such as elasticity and strength, with decreasing content of monols within the polyoxypropylene polyol, although the physical properties of the polyurethane are inferior to those of polyurethane products prepared using the polyoxybutylene polyol only.

Further, Korean Patent Laid-open No. 1988-5233 discloses a method for preparing a sealant composition with optimum stability during feeding of a pretreated powder, a prepolymer and additives and transport of the mixture in a closed state. However, this method disadvantageously involves an increase in preparation cost.

### DISCLOSURE

### Technical Problem

Therefore, it is one object of the present invention to provide a polyurethane composition that is highly stable during storage and can be dehydrated without any pretreatment at high temperatures for a long time, which comprises di- and/or trifunctional polyoxypropylene polyols with a low monol content, and a blocked amine compound and a monomeric vinyl silane as additives for dehydration.

It is another object of the present invention to provide a method for preparing the polyurethane composition.

The use of the polyols having a low monol content in the polyurethane composition of the present invention ensures improved storage stability when compared to conventional prepolymers. In addition, the use of the blocked amine compound and the monomeric vinyl silane as additives for dehydration in open equipment avoids the need for drying of conventional polyurethane compositions in closed equipment at high temperatures for a long time, which offers the advantage of reduced preparation costs.

### TECHNICAL SOLUTION

In accordance with one aspect of the present invention, there is provided a moisture-curable polyurethane composition with improved storage stability, the composition comprising a prepolymer prepared by reacting di- and/or trifunctional polyols having a weight-average molecular weight of 1,000 to 5,000 with a mixture of an aromatic diisocyanate and an aliphatic diisocyanate in a weight ratio of 1:1 to 1:0.1, an inorganic paste, and a blocked amine compound and a monomeric vinyl silane as additives for removing moisture from the inorganic paste.

In accordance with another aspect of the present invention, there is provided a method for preparing a moisture-curable polyurethane composition with improved storage stability, the method comprising the steps of (a) reacting di- and/or trifunctional polyols with a mixture of an aromatic diisocyanate and an aliphatic diisocyanate to prepare an urethane prepolymer containing unreacted isocyanate groups in an amount of 1 to 5%; (b) adding a blocked amine compound and a monomeric vinyl silane to an inorganic paste, followed by mixing at a temperature of 40 to 90° C. for 1 to 5 hours to remove moisture from the inorganic paste; (c) mixing the prepolymer with the dehydrated inorganic paste in a weight ratio of 1:1 to 1:4; and (d) adding a curing catalyst to the mixture, followed by mixing at a temperature of 40 to 90° C. for 1 to 5 hours.

### BEST MODE

The present invention will now be described in detail.

The present invention provides a moisture-curable polyurethane composition comprising a prepolymer prepared by reacting a polyoxypropylene polyol having a low monol content with a mixture of an aromatic diisocyanate and an aliphatic diisocyanate, an inorganic filler, a plasticizer, and a blocked amine compound and monomeric vinyl silane as additives for removing moisture from the inorganic filler and the plasticizer. The polyurethane composition of the present invention exhibits improved storage stability even in an opened state.

An aromatic diisocyanate and an aliphatic diisocyanate are used as diisocyanates for the preparation of the polyurethane composition of the present invention. Examples of suitable aromatic diisocyanates include, but are not limited to, 4,4′-diphenylmethane diisocyanate, 2,4-toluene diisocyanate, 2,6-toluene diisocyanate, carbodiimide-modified methylene diphenyl diisocyanate (MDI), and polymeric methylene diphenyl diisocyanate. Examples of suitable aliphatic diisocyanates include, but are not limited to, 4,4-dicyclohexyl methane diisocyanate, isophorone diisocyanate (IPDI), 1,4-cyclohexyl methane diisocyanate (CHDI). These diisocyanates may be added alone or as a mixture thereof.

As is known in the art, the use of the aromatic diisocyanate alone can relatively improve the physical properties of the polyurethane composition. But, the aromatic diisocyanate tends to foam under unfavorable conditions, e.g., high temperature and high humidity, due to its excessive reactivity, resulting in a deterioration in the durability of the final product. In addition, the quality of the final product may be seriously affected by yellowing, which is a drawback arising from exposure of aromatic compounds to the ambient conditions. On the other hand, the use of the aliphatic diisocyanate alone has great advantages in that yellowing and foaming are inhibited. But, the use of the aliphatic diisocyanate alone causes poor physical properties of the final product when compared to the use of the aromatic diisocyanate alone.

The mixing of the aromatic diisocyanate with the aliphatic diisocyanate in the specific weight ratio and the reaction of the mixture with the polyol having a low monol content lead to a polyurethane prepolymer having superior physical properties and improved storage stability. The mixing ratio of the aromatic diisocyanate to the aliphatic diisocyanate is in the range of 1:1 to 1:0.1 and preferably 1:1 to 1:0.5 on a weight basis. When the aromatic diisocyanate is used in an amount exceeding the range (i.e. the amount of the aromatic diisocyanate is relatively increased), the above-mentioned problems are inevitable on account of excessive reactivity and yellowing of the aromatic diisocyanate. Meanwhile, when the aromatic diisocyanate is used in an amount below the range (i.e. the amount of the aliphatic diisocyanate is relatively increased), it is difficult to achieve a satisfactory improvement in the mechanical properties of the final product.

Suitable polyols that can be used in the present invention are di- and trifunctional polyoxypropylene polyols with a monol content of 0.005 meq/g or lower. The difunctional polyol has a weight-average molecular weight of about 200 to about 3,000 and preferably about 2,000 to about 3,000. The trifunctional polyol has a weight average molecular weight of about 550 to about 7,000 and preferably about 3,000 to about 5,000. Two kinds of the polyols are mixed. Preferred is a mixture of di- and trifunctional polyols. A proper mixing ratio of the difunctional polyol to the trifunctional polyol is in the range of 3:1 to 1:1, and more preferably in the range of 2.5:1 to 1.5:1. A relatively high amount of the difunctional polyol lowers the crosslinking density of the final polyurethane elastomer, resulting in deterioration of general characteristics, such as mechanical properties, water resistance and heat resistance. Meanwhile, a relatively high amount of the trifunctional polyol leads to an improvement in mechanical properties but causes a problem that it is difficult to form a homogeneous coating due to excessively increased crosslinking density.

When the polyol has a monol content lower than the range defined above, the average number of functional groups is lowered (See Table 1) and the molecular weight of the polyurethane is decreased, thus making it difficult to obtain the intended physical properties of the polyurethane. When the polyol has a molecular weight lower than the range defined above, the physical properties, such as hardness and tensile strength, of the polyurethane are effectively improved but the elasticity, which is an inherent characteristic of polyurethanes, is reduced. Meanwhile, when the polyol has a molecular weight exceeding the range defined above, the elasticity is increased but the hardness and strength are unfavorably worsened.

Catalysts and processes that have been used to prepare common polyoxypropylene polyols cannot be employed in the present invention. A bimetallic catalyst is used to prepare the polyol having a monol content not higher than 0.005 meq/g. Such bimetallic catalysts were already reported in U.S. Pat. Nos. 3,427,256, 4,843,054 and 5,952,261. Further, a bimetallic catalyst disclosed in Korean Patent Application No. 2003-44456, which was filed by the present applicant, can also be used to prepare the polyol.

On the other hand, the content of unreacted isocyanate groups, which is dependent on a ratio between the diisocyanates and the polyol used to prepare the prepolymer, has a great influence on the hardness, strength and reactivity of the final polyurethane elastomer. That is, as the content of unreacted isocyanate groups is increased, the hardness and strength of the polyurethane elastomer increase. At this time, since the reactivity of the polyurethane elastomer also increases, it is difficult to obtain stable particles during a water-dispersion process.

Therefore, it is important to maintain the content of isocyanate groups within the prepolymer at an appropriate level. At this time, the content of unreacted isocyanate groups is preferably maintained in the range of 1 to 5% and most preferably in the range of 2 to 4%. If the content of unreacted isocyanate groups is higher than 5%, the strength and hardness of the polyurethane are improved due to increased content of hard segments of the polyurethane. However, there is a danger of foaming of the polyurethane under high temperature and high humidity conditions due to increased reactivity of the polyurethane. Meanwhile, if the content of unreacted isocyanate groups is lower than 1%, the molecular weight of the prepolymer is increased and the number of hydrogen bonds within the prepolymer is increased. As a result, the viscosity of the prepolymer is excessively increased, thus causing poor workability. Therefore, it is important to maintain the content of unreacted isocyanate groups at an appropriate level. When two polyols having the same content of unreacted isocyanate groups are compared, a polyol having a relative low monol content is preferably used because it can be used to prepare a polymer having a more extended chain.

For the removal of moisture from the inorganic filler and the plasticizer mixed with the prepolymer, a blocked amine compound, such as an aldimine-oxazolidine copolymer, is added in an amount of 5 to 20% by weight, based on the total weight of the composition. According to conventional techniques, additives, such as ketimines, enamines, aldimines and oxazolidines, are used to remove moisture from inorganic fillers. These additives must be used in an amount exceeding the moisture content, and residues remaining after dehydration of the inorganic fillers inhibit the moisture from directly reacting with terminal isocyanate groups of a prepolymer. Furthermore, residual amino groups may readily react with terminal isocyanate groups, which are main constituent groups of a prepolymer, causing curing of a final composition product upon exposure to room temperature. Ketimines and enamines cannot be used since they are susceptible to hydrolysis and thus show poor storage stability. Oxazolidines are advantageous in storage stability but they cannot be used in winter due to their slow curing rate. In an attempt to solve these problems, an aldimine-oxazolidine copolymer is used in the composition of the present invention. Although the aldimine-oxazolidine copolymer is not used, the composition of the present invention is seldom cured, thus assuring good storage stability for a long period of time. When the aldimine-oxazolidine copolymer is used, it acts to remove moisture from the inorganic filler and is hydrolyzed by moisture in the air. During hydrolysis, aldimine groups generate primary amine groups, and oxazolidine groups generate secondary amine groups and hydroxyl groups. These groups undergo an addition reaction with the isocyanate groups of the polyurethane to form crosslinking bonds and cause curing of the polyurethane. The series of crosslinking and curing prevents the evolution of carbon dioxide, which is a problem arising from curing of conventional moisture-curable compositions, and as a result, foaming no longer occurs.

Furthermore, a monomeric vinyl silane, such as vinyltriethoxy silane, vinyltrimethoxy silane or vinylmethoxydimethoxy silane, is preferably added to remove moisture from the inorganic filler and the plasticizer. The removal of moisture using the monomeric vinyl silane can be achieved by converting moisture present in an inorganic paste containing a plasticizer, silica and calcium carbonate to an alcohol and evaporating the alcohol under vacuum. At this time, the monomeric vinyl silane is selected from vinyltriethoxy silane, vinyltrimethoxy silane and vinylmethoxydimethoxy silane. The amount of the monomeric vinyl silane used is in the range of 50 to 300% and preferably 200 to 300% of the theoretical moisture content. This removal of moisture leads to an improvement in the storage stability of the final product.

The inorganic filler is preferably treated with an organic material so that moisture cannot be readily absorbed therein. Examples of suitable inorganic fillers include calcium carbonate, titanium oxide, active bentonite, carbon black, and PVC. These inorganic fillers may be used alone or in combination. Examples of suitable plasticizers include phthalate ester, phosphate ester, and adipate ester. The inorganic filler may be further blended with an antioxidant, a UV absorber, a pigment, a solvent, and other additives.

As a curing catalyst that is added to prepare the polyurethane composition of the present invention, there can be used, for example, an organotin catalyst, an amine catalyst or an organic acid catalyst. Of these curing catalysts, an amine catalyst, such as dimethylaminoethyl morpholine, is preferably used, since it causes no deterioration of activity resulting from hydrolysis during storage. The curing catalyst may be added in a predetermined amount relative to the prepolymer.

The above-mentioned components are mixed and packaged in a closed state by a method well known in the art. In accordance with common preparation methods of two-component reaction-curable polyurethane compositions, first, the inorganic paste is stirred at 40-90° C. for 1-5 hours and preferably at 60-80° C. for 3-4 hours to completely remove moisture present therein. Then, the prepolymer and the catalyst are added to the dry paste. The mixture is stirred at 40-90° C. for up to one hour and preferably at 40-60° C. for 20-40 minutes to remove gases contained therein, and it is then packaged.

Although the polyol having a low monol content causes a deterioration in the quality of the final polyurethane, the prepolymer has improved storage stability when compared to conventional prepolymers. In addition, the use of the blocked amine compound and the monomeric vinyl silane as additives for the removal of moisture from the inorganic filler during stirring in open equipment avoids the need for dehydration and drying of conventional polyurethane compositions in closed equipment at high temperatures for a long time, which offers the advantage of reduced preparation costs.

### MODE FOR INVENTION

The present invention will be better understood from the following examples. These examples are not to be construed as limiting the scope of the invention.

### EXAMPLES

### Example 1

1,800 parts by weight of a mixture (2:1) of a difunctional polyoxipropylene polyol (PPG, DF-2000 available from SKC Co., Ltd.) and a trifunctional polyoxipropylene polyol (PPG, TF-5000 available from SKC Co., Ltd.) was added to 300 parts by weight of a mixture (1:0.5) of 4,4′-diphenylmethane diisocyanate (MDI, Cosmonate PH available from Kumho Mitsui Chemicals, Inc.) as an aromatic diisocyanate and isophorone diisocyanate (IPDI, Degussa Inc.) as an aliphatic diisocyanate. The resulting mixture was allowed to react at 80° C. for 12 hours to prepare an isocyanate-terminated urethane prepolymer.

The content of unreacted cyano groups in the prepolymer was 2.8%, as measured using n-dibutylamine back titration.

Subsequently, a plasticizer, calcium carbonate, silica, a aldimine-oxazolidine copolymer and vinyltrimethoxy silane were added to the prepolymer. The mixture was stirred at a high speed at 50° C. for 3 hours to remove gases contained therein. When the stirring was conducted at a low temperature, moisture contained in the inorganic materials could not be readily removed, requiring stirring for an extended time. Meanwhile, when the stirring was conducted at too high a temperature, it took a long time to cool down in a subsequent step.

The prepolymer was slowly stirred together with an inorganic paste for about one hour to remove gases contained therein, and then dimorpholinodiethyl ether as a curing catalyst was added to the mixture to prepare a sealant composition.

### Example 2

A sealant composition was prepared in the same manner as in Example 1, except that the difunctional polyol and the trifunctional polyol were mixed in a ratio of 1:1 to prepare a prepolymer.

### Example 3

A sealant composition was prepared in the same manner as in Example 1, except that a difunctional polyoxipropylene polyol (PPG, LH-2002 available from SKC Co., Ltd.) having a low monol content of 0.003 meq/g and a trifunctional polyoxipropylene polyol (PPG, LF-5003 available from SKC Co., Ltd.) having a low monol content of 0.004 meq/g were used.

### Example 4

A sealant composition was prepared in the same manner as in Example 1, except that the amount of the blocked amine compound used was decreased to ½.

### Example 5

A sealant composition was prepared in the same manner as in Example 1, except that the amount of the vinyltrimethoxy silane was decreased to ⅓.

### Comparative Example 1

A sealant composition was prepared in the same manner as in Example 1, except that the difunctional polyol and the trifunctional polyol were mixed in a ratio of 1:3 to prepare a prepolymer.

### Comparative Example 2

A sealant composition was prepared in the same manner as in Example 1, except that an aldimine was used instead of the aldimine-oxazolidine copolymer.

### Comparative Example 3

A sealant composition was prepared in the same manner as in Example 1, except that an oxazolidine was used instead of the aldimine-oxazolidine copolymer.

The prepolymers thus prepared were evaluated for storage stability, and the final products were evaluated for mechanical properties, reactivity and storage stability. The results are shown in Tables 2 to 4.

<Storage Stability of Prepolymers>

Each of the prepolymers was put in a nitrogen-filled glass bottle and stored in a convection oven at 50° C. for 4 weeks. After storage for 4 weeks, a change in the number of NCO groups and an increase in viscosity were measured.

<Mechanical Properties of Sealants>

3 mm-thick samples were prepared from each of the compositions. The reactivity of the specimens was evaluated. After the compositions were cured for two weeks, they were cut into specimens using ASTM Die C. The physical properties of the specimens were evaluated using UTM.

<Reactivity (Finger Touch Drying Time) of Sealants>

3 mm-thick samples were prepared from the sealants by the same procedure as described above. A PE film was attached to each of the samples and peeled. The time until no sealant remained on the PE film was measured.

<Foamability of Sealants>

3 mm-thick samples were prepared from the sealants by the same procedure as described above. After the samples were cured and cut, the occurrence of foam was visually observed.

<Storage Stability of Sealants>

Each of the composition samples was filled and sealed in a high-density polyethylene cartridge without occurrence of foam. After the cartridge was stored in a convection oven at 50° C. for 4 weeks, a variation in the viscosity of the samples was measured.

TABLE 2
Physical property of prepolymers

| Prepolymer | Example 1 | Example 2 | Example 3 |
|---|---|---|---|
| Variation in viscosity | 1.3 | 1.5 | 1.2 |
| (storage stability, | (12) | (9) | (12) |
| month) | | | |

Table 2 shows test results for the storage stability of the prepolymers. The storage stability of the prepolymers was evaluated by measuring a difference between the initial viscosity and the final viscosity. That is, the variation in viscosity is indicative of the storage stability of the prepolymers. The storage stability of the prepolymers was maintained for about 9 months to about 12 months, which indicates that the prepolymers have excellent storage stability as compared to conventional prepolymers (9 months or less).

TABLE 3
Physical properties of moisture-curable compositions

| | Example No. | | | | | | | |
|---|---|---|---|---|---|---|---|---|
| | | | | | | Comp. | Comp. | Comp. |
| | Ex. 1 | Ex. 2 | Ex. 3 | Ex. 4 | Ex. 5 | Ex. 1 | Ex. 2 | Ex. 3 |
| repolymer | 100 | 100 | 100 | 100 | 100 | 100 | 100 | 100 |
| iller | 200 | 200 | 200 | 200 | 200 | 200 | 200 | 200 |
| (calcium carbonate) | | | | | | | | |
| Plasticizer (DOP) | 100 | 100 | 100 | 100 | 100 | 100 | 100 | 100 |
| Blocked amine | 10 | 10 | 10 | 5 | 10 | 10 | 5 | 5 |
| compound | | | | | | | | |
| Vinyltrimethoxy silane | 15 | 15 | 15 | 15 | 15 | 15 | 15 | 15 |
| Other additives | 10 | 10 | 10 | 10 | 10 | 10 | 10 | 10 |
| Dimorpholinodiethyl | 0.1 | 0.1 | 0.1 | 0.1 | 0.1 | 0.1 | 0.1 | 0.1 |
| ether | | | | | | | | |
| Finger touch drying | 80 | 80 | 60 | 100 | 60 | 60 | 60 | 180 |
| time | | | | | | | | |
| Tensile strength | 0.2 | 0.22 | 0.26 | 0.18 | 0.2 | 0.25 | 0.12 | 0.1 |
| Elongation | 850 | 950 | 1000 | 800 | 850 | 1100 | 650 | 700 |
| Occurrence of foams | No | No | No | No | No | No | Yes | No |
| Storage stability | 1.7 | 2.0 | 1.5 | 2.8 | 2.6 | 2.7 | gel | 3 |

As can be seen from the results of Tables 2 and 3, the use of the polyols having a low monol content ensures improved physical properties while maintaining superior storage stability, as compared to the use of general polyols. As the content of the trifunctional polyol increased, the physical properties were improved. However, when the amount of the trifunctional polyol was above the predetermined range, the storage stability was worsened. Further, the use of the aldimine-oxazolidine copolymer as a blocked amine compound resulted in improved storage stability, compared to the use of aldimine or oxazolidine alone.

### INDUSTRIAL APPLICABILITY

As apparent from the above description, the use of the polyol having a low monol content in the polyurethane composition of the present invention ensures improved storage stability when compared to conventional prepolymers. In addition, the use of the blocked amine compound and the monomeric vinyl silane as additives for the removal of moisture from the inorganic filler during stirring in open equipment avoids the need for dehydration and drying of conventional polyurethane compositions in closed equipment at high temperatures for a long time, which offers the advantage of reduced preparation costs.

1. A moisture-curable polyurethane composition with improved storage stability, the composition comprising:
a prepolymer prepared by reacting di- and/or trifunctional polyols having a weight-average molecular weight of 1,000 to 5,000 with a mixture of an aromatic diisocyanate and an aliphatic diisocyanate in a weight ratio of 1:1 to 1:0.1;
an inorganic paste; and
a blocked amine compound and a monomeric vinyl silane as additives for removing moisture from the inorganic paste.

2. The polyurethane composition according to claim 1, wherein the aromatic diisocyanate is selected from the group consisting of 4,4′-diphenylmethane diisocyanate, 2,4-toluene diisocyanate, 2,6-toluene diisocyanate, carbodiimide-modified methylene diphenyl diisocyanate (MDI), and polymeric methylene diphenyl diisocyanate.

3. The polyurethane composition according to claim 1, wherein the aliphatic diisocyanate is selected from the group consisting of 4,4-dicyclohexyl methane diisocyanate, isophorone diisocyanate, and 1,4-cyclohexyl methane diisocyanate.

4. The polyurethane composition according to claim 1, wherein the polyols have a monol content of 0.005 meq/g or lower.

5. The polyurethane composition according to claim 1, wherein the difunctional polyol and the trifunctional polyol are mixed in a ratio of 3:1 to 1:1.

6. The polyurethane composition according to claim 1, wherein the inorganic paste is composed of an inorganic filler, a plasticizer, an antioxidant, a UV absorber, a pigment, and a solvent.

7. The polyurethane composition according to claim 1, wherein the blocked amine compound is an aldimine-oxazolidine copolymer.

8. The polyurethane composition according to claim 1, wherein the monomeric vinyl silane is vinyltriethoxy silane, vinyltrimethoxy silane, or vinylmethoxydimethoxy silane.

9. A method for preparing a moisture-curable polyurethane composition with improved storage stability, the method comprising the steps of:
(a) reacting di- and/or trifunctional polyols with a mixture of an aromatic diisocyanate and an aliphatic diisocyanate to prepare an urethane prepolymer containing unreacted isocyanate groups in an amount of 1 to 5%;
(b) adding a blocked amine compound and a monomeric vinyl silane to an inorganic paste, followed by mixing at a temperature of 40 to 90° C. for 1 to 5 hours to remove moisture from the inorganic paste;
(c) mixing the prepolymer with the dehydrated inorganic paste in a weight ratio of 1:1 to 1:4; and
(d) adding a curing catalyst to the mixture, followed by mixing at a temperature of 40 to 90° C. for 1 to 5 hours.

10. The method according to claim 9, wherein the monomeric vinyl silane is used in an amount of 50 to 300% of the theoretical moisture content.

11. The method according to claim 9, wherein the inorganic paste is composed of an inorganic filler, a plasticizer, an antioxidant, a UV absorber, a pigment, and a solvent.

12. The method according to claim 9, wherein the inorganic filler is calcium carbonate, titanium oxide, active bentonite, carbon black, or PVC.

13. The method according to claim 9, wherein the plasticizer is a phthalate ester, a phosphate ester, or an adipate ester.

14. The method according to claim 9, wherein the curing catalyst is dimethylaminoethyl morpholine as an amine catalyst.
